(19) United States
(12) Patent Application Publication
(10) Pub. No.: US 2024/0301232 A1
(43) Pub. Date: Sep. 12, 2024

(54) AQUEOUS ROOF COATING COMPOSITION AND METHOD FOR MAKING THE SAME

(71) Applicant: Wacker Chemie AG, Munich (DE)

(72) Inventors: Carol Quinn, Schwenksville, PA (US); Christian Daniels, Fogelsville, PA (US)

(73) Assignee: Wacker Chemie AG, Munich (DE)

(21) Appl. No.: 18/693,223

(22) PCT Filed: Oct. 27, 2021
(86) PCT No.: PCT/EP2021/079775

§ 371 Date: Mar. 19, 2024

(51) Int. Cl. C09D 131/04; C08F 218/08; C08K 5/07; C09D 5/02; C09D 7/45; C09D 7/48; C09D 7/63

(52) U.S. Cl. CPC C09D 131/04; C08F 218/08; C08K 5/07; C09D 5/022; C09D 7/45; C09D 7/48; C09D 7/63; C08F 2800/20

(57) ABSTRACT

An aqueous roof coating composition includes an aqueous dispersion. The aqueous dispersion includes vinyl acetate ethylene copolymers that include 50 to 70% by weight vinyl acetate, 20% or more by weight ethylene, 0.1 to 5% by weight a first functional comonomer, and 0.1 to 5% by weight a second functional comonomer. The aqueous roof coating composition also includes a filler. The aqueous roof coating composition has 35 to 55% by weight vinyl acetate ethylene copolymer solids, 25 to 40% by weight filler, optionally 1 to 15% by weight pigment, and optionally other additives. The vinyl acetate ethylene copolymer exhibits a Tg of −25 to −15° C.

### BACKGROUND

The invention relates in general to an aqueous roof coating composition. The invention also relates to a method for making the roof coating composition.

White elastomeric roof coatings are often added to roofing substrates to add a layer of protection to the roofing substrate from the effects of weathering like corrosion. Typically, such coatings are also formulated to be white in color in order to reflect near infrared energy from the sun, which lowers heat load and provides an overall energy and cost savings.

Elastomeric roof coating compositions known in the art are often based on acrylic polymers. Coatings based on acrylic polymers typically exhibit high tensile strength, elongation, and water resistance properties. However, acrylic polymers are expensive to manufacture and roof coatings based on acrylic polymers typically require that the composition contain zinc oxide to achieve the desired tensile strength and water resistance.

Therefore, it would be desirable to provide a roof coating composition that overcomes the aforementioned deficiencies. A method for making such a roof coating composition would also be desirable.

### BRIEF SUMMARY

Embodiments of an aqueous roof coating composition are described below.

In an embodiment, the aqeuous roof coating composition comprises an aqueous dispersion. The aqueous dispersion comprises vinyl acetate ethylene copolymers that include 50 to 70% by weight of vinyl acetate, 20% or more by weight of ethylene, 0.1 to 5% by weight of a first functional comonomer, and 0.1 to 5% by weight of a second functional comonomer. The aqueous roof coating composition also comprises a filler. The aqueous roof coating composition has 35 to 55% by weight vinyl acetate ethylene copolymer solids, 25 to 40% by weight of filler, optionally 1 to 15% by weight of pigment, and optionally other additives. The % by weight of the solids, filler, and pigment are based on the total solids of the composition. The vinyl acetate ethylene copolymer exhibits a Tg of −25 to −15° C.

In some embodiments, the aqueous roof coating composition further comprises one or more UV-VIS absorbers in an amount of 0.01 to 2 wt %, based on the weight of copolymer solids of the composition. In an embodiment, one or more UV-VIS absorber is present an amount of 0.01 to 0.5 wt %, based on the weight of copolymer solids of the composition. In another embodiment, the one or more UV-VIS absorber includes 4-methyl benzophenone.

In other embodiments, the composition contains no protective colloids.

In some embodiments, the vinyl acetate ethylene copolymers comprise 0.1 to 2% by weight of the first functional comonomer.

In other embodiments, the vinyl acetate ethylene copolymers comprise a total of 1 to 5% by weight of the first functional comonomer and the second functional comonomer.

In an embodiment, the first functional comonomer is an unsaturated carboxylic acid.

In an embodiment, the second functional comonomer is an ethylenically unsaturated carboxamide.

In another embodiment, the second functional comonomer is an unsaturated carboxylate ester.

In some embodiments, the vinyl acetate ethylene copolymers further comprise a third functional comonomer which is an ethylenically unsaturated sulphonic acid or a salt thereof.

In some embodiments, the vinyl acetate ethylene copolymers include ethylene in an amount of 30 to 40% by weight.

In other embodiments, the aqueous roof coating composition further comprises an emulsifier in an amount of 0.1 to 3% by weight.

In some embodiments, the aqueous roof coating composition when dried exhibits a water swell of 20% or less after being submerged in water for 168 hours.

In some embodiments, the aqueous roof coating composition when dried exhibits a tensile strength of 200 psi or more at 22.8° C. and a relative humidity of 50% and an elongation at break of 100 to 500% at 22.8° C.

In other embodiments, the aqueous roof coating composition when dried exhibits a permeance of 50 US perms or less at 22.8° C. and a relative humidity of 50%.

Also, embodiments of a method for making the aqueous roof coating composition are described below.

In an embodiment, the method comprises forming a mixture of water, vinyl acetate monomers, and ethylene by directing the vinyl acetate monomers and ethylene into a reactor containing water. The reactor is pressurized to 800 psi or more. The vinyl acetate monomers, ethylene, a first functional comonomer, and a second functional comonomer are reacted by way of a radically initiated, polymerization process in the presence of an emulsifier to form vinyl acetate ethylene copolymers exhibiting a Tg of −25 to −15° C., wherein 2 to 20% by weight of the vinyl acetate monomers, based on the total weight of the mixture in the reactor, remain unreacted while vinyl acetate monomers are being fed into the reactor. The vinyl acetate ethylene copolymers are mixed with a filler to form and aqueous roof coating composition that comprises 35 to 55% by weight of the vinyl acetate ethylene copolymer solids, 25 to 40% by weight of the filler, optionally 1 to 15% by weight of pigment, and optionally other additives, all % by weight are based on the total solids of the composition.

In some embodiments, a first amount of vinyl acetate monomers are directed to the reactor as an initial charge and a second amount of vinyl acetate monomers are fed to the reactor in a second amount. In an embodiment, the first functional comonomer and the second functional comonomer are fed into the reactor after the first amount of the vinyl acetate monomers are fed into the reactor.

In other embodiments, the reactor is pressurized to between 800 and 1600 psi.

In certain embodiments, the % by weight of unreacted vinyl acetate monomers in the mixture is maintained within a predetermined range during the polymerization process.

In some embodiments, 4 to 8% by weight of the vinyl acetate monomers, based on the total weight of the mixture in the reactor, remain unreacted while the vinyl acetate monomers are being fed into the reactor.

In other embodiments, the filler is selected from the group consisting of calcium carbonate, talc, and mixtures thereof.

In certain embodiments, unreacted vinyl acetate monomers are removed from the aqueous dispersion.

In an embodiment, the emulsifier is anionic and present in an amount of 3% or less based on by weight, based on the total weight of the monomers.

### DETAILED DESCRIPTION

It is to be understood that the invention may assume various alternative orientations and step sequences, except where expressly specified to the contrary. It is also to be understood that the specific materials, devices, and methods described in the following specification are simply exemplary embodiments of the inventive concepts. Hence, specific properties, conditions, or other physical characteristics relating to the embodiments disclosed are not to be considered as limiting, unless expressly stated otherwise.

In an embodiment, an aqueous roof coating composition is provided. The aqueous roof coating composition may be applied to roofing materials known in the art. After being applied, the aqueous roof coating composition is typically allowed to dry under ambient conditions. The dried roof coating composition may be utilized to protect the roof it is applied to. The roof coating composition may be utilized for commercial, residential, or industrial roofs. However, the roof coating composition may be utilized in other roofing applications.

In an embodiment, the aqueous roof coating composition comprises an aqueous dispersion. The aqueous dispersion comprises polymers dispersed in water and will be discussed primarily with respect to copolymers. However, the aqueous dispersion may comprise homopolymers or a mixture of homopolymers and copolymers. In certain embodiments, the polymers may be utilized as a binder in the roof coating composition.

The aqueous dispersion comprises vinyl acetate ethylene (VAE) copolymers. Thus, the aqueous dispersion may also be referred to herein as the “aqueous dispersion of VAE copolymers.” The VAE copolymers are formed by copolymerizing vinyl acetate monomers, ethylene, a first functional comonomer, and a second functional comonomer in water.

Preferably, the vinyl acetate monomers are copolymerized in the VAE copolymers in an amount of 50 to 70% by weight, which is based on the total weight of monomers in the aqueous dispersion.

Ethylene is copolymerized in the VAE copolymers in an amount of 20% or more by weight. Preferably, ethylene is copolymerized in the VAE copolymers in an amount of 30% or more by weight. In some embodiments, ethylene is in the VAE copolymers in an amount of 30 to 40% by weight, more preferably, 30-35% by weight. In all cases, the % by weight of ethylene is based on the total weight of monomers in the aqueous dispersion. Copolymerizing an amount of ethylene as specified above into the VAE copolymers provides the copolymers with a molecular weight that enables the roof coating composition to exhibit a desirable elongation and tensile strength.

The first functional comonomer is copolymerized in the VAE copolymers in an amount from 0.1 to 5% by weight, preferably 0.1 to 2% by weight, which in each case based on the total weight of monomers in the aqueous dispersion. More preferably, the first functional comonomer is in the copolymer in an amount of 0.5 to 1.5% by weight, which is based on the total weight of monomers in the aqueous dispersion.

The second functional comonomer is copolymerized in the VAE copolymers in an amount from 0.1 to 5% by weight, preferably 0.1 to 3.5% by weight, in either case based on the total weight of monomers in the aqueous dispersion. More preferably, the second functional comonomer is in the copolymer in an amount of 0.1 to 2% by weight based on the total weight of monomers in the aqueous dispersion. In some embodiments, the second functional comonomer is in the copolymer in an amount of 1 to 2% by weight based on the total weight of monomers in the aqueous dispersion.

In certain embodiments, and after conducting the polymerization process, the VAE copolymers comprise a total of 1 to 5% by weight of the first functional comonomer and the second functional comonomer. In some embodiments, the VAE copolymer comprises a total of 1 to 4% by weight of the first functional comonomer and the second functional comonomer.

In other embodiments, the VAE copolymers comprise additional functional comonomers, for example, a third functional comonomer. In an embodiment, the third functional comonomer is copolymerized in an amount from 0.1 to 1% by weight, preferably 0.2 to 1% by weight, in each case based on the total weight of monomers in the aqueous dispersion.

Examples of functional comonomers are ethylenically unsaturated monocarboxylic and dicarboxylic acids, typically acrylic acid, methacrylic acid, fumaric acid, itaconic acid, crotonic acid, and maleic acid; ethylenically unsaturated carboxamides such as acrylamide, diacetone acrylamide, methacrylamide and functional acrylamides such as n-methylol acrylamide, isobutoxy acrymide; monoesters of fumaric acid and maleic acid, such as the ethyl and isopropyl esters, and also maleic anhydride, ethylenically unsaturated sulphonic acids and their salts, typically vinylsulphonic acid, 2-acrylamido-2-methyl-propanesulphonic acid. Acrylates such as acetoacetoxyethy methacrylate, di and tri acrylates, trially cyanurate, and diallyl fumarate are also suitable for use as functional comonomers.

Also suitable as functional comonomers are ethylenically unsaturated, hydrolyzable silane monomers, for example γ-acryloyl- and γ-methacryloyloxypropyltri(alkoxy)silanes, vinylalkyldialkoxysilanes, and vinyltrialkoxysilanes, having C₁ to C₁₂ alkoxy groups and optionally C₁ to C₃ alkyl radicals. Ethylenically unsaturated, hydrolyzable silane monomers that are most preferred are vinyltrimethoxysilane, vinyltriethoxysilane, 3-methacryloyl-oxypropyltrimethoxysilane, 3-methacryloyloxypropyltriethoxysilane.

Preferably, the first functional comonomer is an unsaturated carboxylic acid and the second functional comonomer is an ethylenically unsaturated carboxamide or an unsaturated carboxylate ester. More particularly, it is preferred that the first functional comonomer is acrylic acid and the second functional comonomer is acrylamide. When the VAE copolymers comprise a third functional comonomer, in some embodiments, the third functional comonomer may be an ethylenically unsaturated sulphonic acid or a salt thereof. In other embodiments, the third functional comonomer may be a hydrolyzable silane monomer such as, for example, a vinyltriethoxysilane or another ethylenically unsaturated, hydrolyzable silane compound listed above. In still other embodiments, the third functional comonomer may be an ester of acrylic acid such as, for example, hydroxyethyl acrylate. In other embodiments, the third functional comonomer may be an allyl ether having a uriedo functional group. Alternative monomers having a uriedo functional group may also be suitable for use.

Preferably, the functional monomers are selected in such a manner that protective colloids such as, for example, polyvinyl alcohol are not utilized to form the aqueous dispersion of the VAE copolymers. While protective colloids are well established as a dispersion stabilizers, the use of a protective colloid generally results in an aqueous dispersions that contain larger particles. Furthermore, utilizing a protective colloid such as polyvinyl alcohol may increase the water swell and permeability of the roof coating composition when dried, which is not desirable. Thus, in certain embodiments, the aqueous roof coating composition contains no protective colloids.

In some embodiments, the VAE copolymers may include 0 to 35% by weight, preferably 0 to 10% by weight, in each case based on the total weight of monomers in the aqueous dispersion, of other non-functional monomers. Non-functional monomers can be selected from the group consisting of vinyl chloride, vinyl esters and (meth)acrylic acid esters. Suitable other vinyl esters are those of carboxylic acids with 3 to 12 carbon atoms such as vinyl propionate, vinyl butyrate, vinyl 2-ethylhexanoate, vinyl laurate, 1-methyl vinyl acetate, vinyl pivalate and vinyl esters of alpha-branched monocarboxylic acids with 9 to 11 carbon atoms, such as VeoVa™9R, VeoVa™10R, or VeoVa™11R (available from Hexion Specialty Chemicals, Inc., Columbus, OH). Suitable methacrylic or acrylic acid esters are esters of straight-chain or branched alcohols having 1 to 15 C atoms, for example methyl acrylate, methyl methacrylate, ethyl acrylate, ethyl methacrylate, propyl acrylate, propyl methacrylate, butyl acrylate (n-, iso- and tert-), n-butyl methacrylate, 2-ethylhexyl acrylate, isobornyl acrylate, 2-propylheptyl acrylate and norbornyl acrylate. Methyl acrylate, methyl methacrylate, butyl acrylate and 2-ethylhexyl acrylate are preferred. A preferred non-functional monomer is a sodium salt of acrylamido methyl propane sulfonic acid. Other sulfonic acids such as sodium vinyl sulfonate can also be used. Such non-functional monomers may be introduced for the adjustment of the glass transition temperature or of the hydrophobic characteristics of the VAE copolymers.

The monomers are preferably selected so that the VAE copolymers exhibit a glass transition temperature (Tg) of −25° C. to −15° C. Utilizing VAE copolymers exhibiting a glass transition temperature in the aforementioned range provides a roof coating composition that exhibits desirable low temperature flexibility. The glass transition temperature (Tg) of the VAE copolymers can be determined in a known way by means of differential scanning calorimetry (DSC) with a heating rate of 10° K per minute according to ASTM D3418-82 as onset temperature. The Tg may also be calculated approximately in advance by means of the Fox equation. According to Fox T. G., Bull. Am. Physics Soc. 1, 3, page 123 (1956), it holds that: 1/Tg=x1/Tg1+x2/Tg2+ . . . +xn/Tgn, where xn is the mass fraction (% by weight/100) of the monomer n and Tgn is the glass transition temperature, in Kelvin, of the homopolymer of the monomer n. Tg values for homopolymers are listed in Polymer Handbook, 2nd Edition, J. Wiley & Sons, New York (1975).

As noted above, the VAE copolymers are formed by a polymerization process. Preferably, the VAE copolymers are formed by a radically initiated, aqueous emulsion polymerization process. Such a polymerization process can be conducted to yield the aqueous dispersion of VAE copolymers. In certain embodiments, the polymerization process takes place in a pressure reactor. The pressure reactor can be utilized to form a mixture of water, vinyl acetate monomers, and ethylene. The mixture may also comprise other desired monomers and components that will be utilized to yield the aqueous dispersion of VAE copolymers.

For example, in some embodiments, the aqueous dispersion of VAE copolymers is formed by adding an amount of initiator to the mixture. The initiator may be a redox initiator combination such as those that are customary for emulsion polymerization.

Examples of suitable oxidation initiators are the sodium, potassium, and ammonium salts of peroxodisulfuric acid, hydrogen peroxide, t-butyl peroxide, t-butyl hydroperoxide, potassium peroxodiphosphate, tert-butyl peroxopivalate, cumene hydroperoxide, isopropylbenzene monohydroperoxide. The stated initiators are used in general in an amount of 0.01 to 2.0% by weight, based on the total weight of the monomers.

Preferably, when utilizing an initiator to form the aqueous dispersion, a reducing agent is also utilized to form the aqueous mixture and control the reaction rate. Suitable reducing agents are the sulfites and bisulfites of the alkali metals and of ammonium, as for example sodium sulfite, the derivatives of sulfoxylic acid such as zinc sulfoxylates or alkali metal formaldehyde sulfoxylates, as for example sodium hydroxymethanesulfinate (Brüggolit), and (iso)ascorbic acid. In some embodiments, it is preferred to use sodium erythorbate, which is the sodium salt of (iso)ascorbic acid, as the reducing agent. The amount of reducing agent is preferably 0.015 to 3% by weight, based on the total weight of the monomers. It is preferred that the amount of reducing agent added to the aqueous dispersion is in molar excess relative to the amount of initiator added to the aqueous dispersion.

The stated oxidizing agents, more particularly salts of peroxodisulfuric acid, may also be used on their own as thermal initiators.

Preferably, the aqueous dispersion of VAE copolymers is formed in the presence of one or more emulsifiers. The one or more emulsifiers are used to stabilize the aqueous dispersion of VAE copolymers. Suitable emulsifiers are nonionic emulsifiers or anionic emulsifiers or mixtures of nonionic and anionic emulsifiers. The amount of emulsifier is preferably 3% or less by weight. In some embodiments, emulsifier in an amount of 0.1 to 3% by weight is utilized. Preferably, the amount of emulsifier utilized is 1.5% by weight or less. For example, the amount of emulsifier utilized may be 0.1 to 1.5% by weight. More preferably, the amount of emulsifier utilized is 1.0% by weight or less. For example, the amount of emulsifier utilized may be 0.1 to 1.0% by weight. In the embodiments described above, % by weight of emulsifier is based on the total weight of monomers used in the polymerization.

Suitable nonionic emulsifiers are, for example, acyl, alkyl, oleyl, and alkylaryl ethoxylates. Suitable nonionic emulsifier products are available commercially, for example, under the names Genapol® or Lutensol®. These products include ethoxylated mono-, di-, and tri-alkylphenols, preferably having a degree of ethoxylation of 3 to 50 ethylene oxide units and C₄ to C₁₂ alkyl radicals, and also ethoxylated fatty alcohols, preferably having a degree of ethoxylation of 3 to 80 ethylene oxide units and C₈ to C₃₆ alkyl radicals. Suitable nonionic emulsifiers are also C₁₃-C₁₅ oxo-process alcohol ethoxylates having a degree of ethoxylation of 3 to 30 ethylene oxide units, C₁₆-C₁₈ fatty alcohol ethoxylates having a degree of ethoxylation of 11 to 80 ethylene oxide units, C₁₀ oxo-process alcohol ethoxylates having a degree of ethoxylation of 3 to 11 ethylene oxide units, C₁₃ oxo-process alcohol ethoxylates having a degree of ethoxylation of 3 to 20 ethylene oxide units, polyoxyethylenesorbitan monooleate having 20 ethylene oxide groups, copolymers of ethylene oxide and propylene oxide with at least 10% by weight of ethylene oxide, polyethylene oxide ethers of oleyl alcohol, having a degree of ethoxylation of 4 to 20 ethylene oxide units, and also the polyethylene oxide ethers of nonylphenol having a degree of ethoxylation of 4 to 20 ethylene oxide units. Particularly preferred are C₁₂-C₁₄ fatty alcohol ethoxylates having a degree of ethoxylation of 3 to 20 ethylene oxide units. Preferred nonionic emulsifiers are copolymers of ethylene oxide and propylene oxide with a minimum content of at least 10% by weight of ethylene oxide.

Examples of suitable anionic emulsifiers are sodium, potassium, and ammonium salts of straight-chain aliphatic carboxylic acids having 12 to 20 C atoms; sodium hydroxyoctadecanesulfonate; sodium, potassium, and ammonium salts of hydroxyl-fatty acids having 12 to 20 C atoms and the sulfonation and/or acetylation products thereof; sodium, potassium, and ammonium salts of alkyl sulfates, also as triethanolamine salts, and sodium, potassium, and ammonium salts of alkylsulfonates having in each case 10 to 20 C atoms and of alkylarylsulfonates having 12 to 20 C atoms; dimethyldialkylammonium chloride having 8 to 18 C atoms and its sulfonation products; sodium, potassium, and ammonium salts of sulfosuccinic esters with aliphatic saturated monohydric alcohols having 4 to 16 C atoms, and sulfosuccinic 4-esters with polyethylene glycol ethers of monohydric aliphatic alcohols having 10 to 12 C atoms, more particularly the disodium salts thereof, and of sulfosuccinic 4-esters with polyethylene glycol nonylphenyl ether, more particularly the disodium salt thereof, and of biscyclohexyl sulfosuccinate, more particularly the sodium salt thereof; lignosulfonic acid and also its calcium, magnesium, sodium, and ammonium salts; resin acids and also hydrogenated and dehydrogenated resin acids, and also their alkali metal salts.

The most preferred anionic emulsifiers are the sodium, potassium, and ammonium salts of alkyl sulfates and of alkylsulfonates having in each case 10 to 20 C atoms, and also of alkylarylsulfonates having 12 to 20 C atoms, and of sulfosuccinic esters with aliphatic saturated monohydric alcohols having 4 to 16 C atoms. Preferably, the anionic emulsifier is sodium lauryl sulfate. Utilizing sodium lauryl sulfate to form the aqueous dispersion has the surprising effect of improving the adhesion of the roof coating composition to the substrate upon which the composition is applied.

In some embodiments, the aqueous, radically initiated emulsion polymerization can proceed under a conventional emulsion polymerization procedure. Examples of such procedures are described in the Encyclopedia of Polymer Science and Engineering, Vol. 8 (1987), John Wiley & Sons, pages 659 to 677 and in EP 1916275 A1. In certain embodiments, the polymerization may take place in a pressure reactor at a temperature of 50° C. to 120° C.

Additionally, it has been discovered that in order to incorporate the desired amount of ethylene into the VAE copolymers and achieve the desired molecular weight of the VAE copolymers, it may be preferred that the polymerization proceed at a high pressure. For example, in certain embodiments, it is preferred that the polymerization occur at a pressure of 800 PSI or more. In some embodiments, the polymerization may occur at a pressure of between 800 and 1600 PSI. Preferably, the polymerization occurs at a pressure of 900 to 1100 PSI. Conducting the polymerization at the pressures noted above has additional benefits. For example, the amount of initiator required to achieve the desired ethylene incorporation can be lowered when compared with polymerization conducted at lower pressures. Furthermore, when the polymerization occurs at the pressures noted above, the high process throughput can be achieved, which may not be achievable for polymerizations occurring at lower pressures.

The desired monomers and ethylene are directed into the reactor. All of the monomers may form an initial charge, or all of the monomers may form a feed, or portions of the monomers may form an initial charge and the remainder may form a feed after the polymerization has been initiated. The feeds may be separate (spatially and chronologically), or all or some of the components may be fed after pre-emulsification. In certain embodiments, a first amount of vinyl acetate monomers are directed to the reactor as an initial charge and a second amount of vinyl acetate monomers are fed to the reactor in a second amount. In one such embodiment, the first functional comonomer and the second functional comonomer may be fed into the reactor after the first amount of the vinyl acetate monomers are provided as an initial charge. Similarly, all of the emulsifier may form an initial charge, or all of the emulsifier may form a feed, or portions of the emulsifier may form an initial charge and the remainder may form a feed after the polymerization has been initiated. The feeds may be separate (spatially and chronologically), or all or some of the components may be fed after pre-emulsification.

It has also been discovered that in order to incorporate the desired amount of ethylene into the VAE copolymers, it is preferred that a predetermined amount of unreacted vinyl acetate monomers are present in the mixture during polymerization. In certain embodiments, it is desired that an amount of unreacted vinyl acetate monomers are present in the mixture when feeding vinyl acetate monomers and ethylene into the reactor. In an embodiment, the amount of unreacted vinyl acetate monomers in the mixture is within a predetermined range. For example, the amount of unreacted vinyl acetate monomers may be from 2 to 20% by weight, preferably, 4 to 8% by weight, in all cases based on the total weight of the mixture in the reactor at the time of measuring. Preferably, during the polymerization process, the percentage of unreacted vinyl acetate monomers is maintained within the predetermined range. However, the percentage of unreacted vinyl acetate monomers may periodically be outside of the predetermined range based on process conditions or the initial amount of unreacted vinyl acetate monomers added to the reactor. It should also be noted that, in certain embodiments, the % by weight of unreacted vinyl acetate monomers may decrease over time as polymerization proceeds. However, in some embodiments, the % by weight of unreacted vinyl acetate monomers may increase at certain periods of the polymerization process. The % by weight of unreacted vinyl acetate monomers can be measured via titration methods known in the art.

After the polymerization is completed, the solids content of the aqueous dispersion of VAE copolymers may be in a range from 45 to 75% by weight. Preferably, the aqueous dispersion has a solids content of 50% by weight or more. In another embodiment, the aqueous dispersion has a solids content of 50 to 65% by weight. In each case, the % by weight is based on the total weight of the aqueous dispersion of VAE copolymers.

In some embodiments, undesirable materials may be removed from the aqueous dispersion of VAE copolymers before the dispersion is utilized in the aqueous roof coating composition. For example, unreacted vinyl acetate monomers may be removed from the aqueous dispersion. Unreacted vinyl acetate monomers can be removed by processes known in the art such as, for example, a striping process. After removing the unreacted vinyl acetate monomers and other undesirables, the aqueous dispersion of VAE copolymers may be ready for use in the aqueous roof coating composition.

The aqueous roof coating composition comprises 35 to 55% by weight of the VAE copolymer solids, 25 to 40% by weight of filler, and optionally 1 to 15% by weight of pigment, all % by weight are based on the total solids of the composition. The aqueous roof coating composition may also comprise other additives. For example, the aqueous roof coating composition may comprise thickener, wetting agents, dispersants, and/or biocide. However, in certain embodiments, it is preferred that no mineral binders, such as cement, are part of the roof coating composition.

Suitable fillers include, for example, calcium carbonate, clay, mica, talc, alumina silicates, alumina hydrate or mixtures of any of these fillers. In some embodiments, it may be preferred that the filler comprises a mixture of calcium carbonate and talc. In other embodiments, the filler is selected from the group consisting of calcium carbonate, talc, and mixtures thereof. Zinc oxide may also be utilized as a filler. However, it has been surprisingly discovered that zinc oxide is not required in order for the roof coating composition to exhibit a desirable tensile strength and water resistance. Suitable pigments may be for example titanium dioxide, iron oxide, or organic pigments. Suitable thickeners are for example urethane thickeners or cellulosic thickeners such as methyl cellulose. Wetting agents known in the art are suitable for use in the aqueous roof coating composition. Dispersants for the stabilization of pigments and fillers may also be present, for example polyacids and their salts such as polymethacrylic acid and its sodium salt.

In certain embodiments, the aqueous roof coating composition comprises one or more UV-VIS absorbers. A UV-VIS absorber may be utilized in the aqueous roof coating composition to help preserve the appearance of the coating by limiting the contamination of the coating by dirt and/or dust particles in the atmosphere. In some embodiments, the aqueous roof coating composition may comprise two or more UV-VIS absorbers. When provided, the one or more UV-VIS absorbers in the aqueous roof coating composition are provided in an amount of 0.01 to 2 wt %, based on the weight of copolymer solids of the composition. Preferably, the one or more UV-VIS absorbers are present in the aqueous roof coating composition in an amount of 0.2 to 2 wt %, based on the weight of copolymer solids of the composition. More preferably, the one or more UV-VIS absorbers are present in the aqueous roof coating composition in an amount of 0.01 to 0.5 wt %, based on the weight of copolymer solids of the composition. UV-VIS absorbers known in the art are suitable for use in the roof coating composition. However, in certain embodiments, the one or more UV-VIS absorbers may be selected from the group consisting of benzophenone, 4-methyl benzophenone, 2,4,6-trimethylbenzophenone, and mixtures thereof. In embodiments where benzophenone is provided in the aqueous roof coating composition, it is preferred that benzophenone is present in the aqueous roof coating composition in an amount less than 0.1 wt %, based on the weight of copolymer solids of the composition. Preferably, the one or more UV-VIS absorbers are a mixture of 2,4,6-trimethylbenzophenone and 4-methylbenzophenone.

The preparation of the aqueous roof coating composition with the aqueous dispersion of VAE copolymers disclosed herein may be according to the formulation principles generally known in the art. For example, an aqueous slurry of filler and pigments may be mixed with the aqueous dispersion of VAE copolymers and the other ingredients in a standard industrial mixer. Water may be added to the composition for obtaining an aqueous roof coating composition with a solids content of 45 to 65% by weight, preferably, 50 to 65% by weight. The roof coating composition preferably has a pigment volume concentration (PVC) of 30 to 50%. PVC can be calculated according to the following formula: PVC (%)=(V_{P+F}×100)/(V_{P+F}+V_{B}) where V_{P+F}=sum of volume of pigment and filler, V_{B}=volume of binder.

Advantageously, when dried, the aqueous roof coating composition may exhibit certain desirable properties without the use of polymers based on expensive acrylic monomers or zinc oxide.

For example, it is preferred that, when dried, the roof coating composition exhibits a desirable wet adhesion when applied to certain roofing materials. In one such embodiment, when dried, the aqueous roof coating exhibits a wet adhesion of 2 pounds per linear inch (lbs per linear inch) or more when applied to galvanized metal. Preferably, when dried, the roof coating exhibits a wet adhesion of 2 to 4 lbs per linear inch when applied to galvanized metal. The wet adhesion of the roof coating composition can be determined by testing in accordance with ASTM C794 using a commercially available tensile tester such as an Instron model 4464.

In other embodiments, when dried, the roof coating composition exhibits a desirable permeance to water. For example, the roof coating composition when dried may exhibit a permeance of 50 US perms or less at 22.8° C. and a relative humidity of 50%. The permeance of the roof coating composition can be determined by testing in accordance with ASTM D1653.

In other embodiments, when dried, the roof coating composition may exhibit a tensile strength of 200 psi or more at 22.8° C. and a relative humidity of 50%. The tensile strength of the roof coating composition can be determined by testing in accordance with ASTM D-2370 using a commercially available tensile tester such as an Instron model 4464.

In other embodiments, when dried, the roof coating composition may exhibit an elongation at break of 100% or more at 22.8° C. Preferably, when dried, the roof coating composition exhibits an elongation at break of 100 to 500% at 22.8° C. The elongation at break of the roof coating composition can be determined by testing in accordance with ASTM D-2370 before and after 1000 hours of xenon arc accelerated weathering using commercially available equipment.

In still other embodiments, the roof coating composition can be formulated to resist water swell. For example, when dried, the roof coating composition may exhibit a water swell of 20% or less after being submerged in water for 168 hours. The permeance of the roof coating composition can be determined by testing in accordance with ASTM D471.

In some embodiments, the aqueous roof coating composition may meet the performance requirements for passing the ASTM D6083 standard, which is the US standard for liquid applied acrylic-based roof coatings, without the use of an acrylic-based roof coating composition.

The aqueous roof coating composition may be applied to a roof by spray, roller, brush or another known method to a substrate. Generally, the aqueous roof coating composition is applied in an amount of about 3.79 to about 7.57 liters per 100 sq. ft., and dried to form a protective coating without cracking. The thickness of the aqueous roof coating composition may be in the range of about 0.635 to 1.27 mm. The thickness of the dried roof coating composition may be in the range of 0.381 to 0.635 mm.

### Examples

Examples, which are within the scope of the invention, are described below. Comparative Examples, which are not within the scope of the invention, are also described below. These examples are presented solely for the purpose of further illustrating and disclosing the embodiments of the roof coating composition and method of making the same.

The VAE copolymers utilized in Examples 1-10 and Comparative Examples 1-2 were prepared in a 1.05 gallon stainless steel autoclave equipped with a jacket for cooling, a mechanical turbine agitator, and metering pumps for addition of the various feeds. Deionized water was used for all experiments. Comparative Examples 3-4 are also described below.

Aqueous Dispersion of VAE Copolymers of Example 1 To form an aqueous dispersion of VAE copolymers an autoclave was charged with 850 g of water, 8.4 g of Aerosol® MA-80-1, which comprises dihexyl sodium sulfosuccinate and was supplied by the Solvay Group, 0.5 g of sodium acetate, 5.0 g of a 1% solution of ferrous ammonium sulfate. The pH of the charge was adjusted to 4.2 with 1.3 g of acetic acid. Agitation was begun and 262.5 g of vinyl acetate was charged. After the initial charging, the reactor was purged with nitrogen followed by a purge with ethylene and heated under agitation to 55° C., then 325 g of ethylene was charged. To initiate polymerization a solution of 5% t-butyl hydroperoxide was fed at 0.8 g/min and an 8% solution of sodium erythorbate was also fed at 0.8 g/min. Upon evidence of an exotherm, two additional feeds were begun. The first feed, which may also be referred to herein as a delay feed, comprised a mixture of 1052 g of vinyl acetate, 14.4 g of acrylic acid, and 4.82 g of vinyl triethoxy silane (referred to in Table 1 as “VTES”) and the second feed consisted of 74.4 g water, 127.6 g of Aerosol® A-102, which was supplied by the Solvay Group, 19.2 g of ATBS 50, which is a 50% solution of the sodium salt of acrylamido methyl propane sulfonic acid, which is referred to below as “ATBS” and was supplied by SNF Inc., and 73.9 g of acrylamide 52% solution in water. Both feeds were delivered to the reactor uniformly over 150 minutes. When the monomer feeds were begun, the temperature was ramped from 55° C. to 75° C. over 90 minutes and then held at 75° C. for the remainder of the reaction. After the pressure had peaked, additional ethylene was added as needed to maintain a running pressure in the reactor of 950 psi, the ethylene addition was complete when a total of 615 g of ethylene were added, after which the pressure was allowed to decay.

The addition rates of the t-butyl hydroperoxide and sodium erythorbate solutions were adjusted over time in an effort to obtain a uniform conversion profile. Both of these additions were terminated at about 190 minutes after the initial exotherm was observed and 205 g of each solution had been added.

The reactor contents were then cooled to 35° C. then transferred to a 3 gallon autoclave where vacuum was used to remove any unreacted ethylene. After removing the unreacted ethylene, 1 g of Rhodaline® 670, which is a proprietary defoamer composition that was supplied by the Solvay Group, was added to reduce foaming, followed by 2 g of sodium erythorbate in 20 g of water, then 2 g of t-butyl hydroperoxide (70%) in 10 g of water. The contents were allowed to mix for 15 minutes and were then removed.

The physical properties of the resulting aqueous dispersion was as follows:

| | |
|---|---|
| % non-volatile | 55.4 |
| T_{g} | −18.6° C. |
| Viscosity | 245 cps (Brookfield LVF viscometer 60 rpm) |
| pH | 5.3 |

The estimated VAE copolymer composition is: 66.1% vinyl acetate, 30.5% ethylene, 0.72% acrylic acid, 1.93% acrylamide, 0.5% ATBS, and 0.25% vinyl triethoxy silane.

### Aqueous Dispersions of VAE Copolymers of Examples 2-7

The procedure of Example 1 was generally followed for the aqueous dispersions of Examples 2-7 with certain changes made to the procedure to account for the number and type of functional monomers utilized in a particular example.

For Examples 2-3 and 6, only a first functional monomer and a second functional monomer were utilized to form the VAE copolymers. The functional monomers utilized in Example 1 were utilized to form the VAE copolymers of Examples 4-5. The functional monomers utilized in Example 7 were acrylic acid and Sipomer® WAM (referred to in Table 1 as “WAM”), which is a uriedo functional monomer that was supplied by the Solvay Group. For Example 7, the Sipomer® WAM monomers were fed into the reactor along with the Aerosol® A-102. The weight percent of the functional monomers added to the reactor to form the VAE copolymers of Examples 2-7 is as shown in Table 1.

For the VAE copolymers of Example 2, the estimated copolymer composition is: 66.5% vinyl acetate, 30.3% ethylene, 0.7% acrylic acid, 0.5% ATBS, and 1.9% acrylamide.

For the VAE copolymers of Example 3, the estimated copolymer composition is: 66% vinyl acetate, 30.5% ethylene, 1% acrylic acid, 0.5% ATBS, and 1.9% acrylamide.

For the VAE copolymers of Example 4, the estimated copolymer composition is: 66.1% vinyl acetate, 30.8% ethylene, 1% acrylic acid, 1.4% acrylamide, 0.5% ATBS, and 0.2% vinyl triethoxy silane.

For the VAE copolymers of Example 5, the estimated copolymer composition is: 65.7% vinyl acetate, 30.7% ethylene, 1% acrylic acid, 1.9% acrylamide, 0.5% ATBS, and 0.2% vinyl triethoxy silane.

For the VAE copolymers of Example 6, the estimated copolymer composition is: 65.6% vinyl acetate, 32.5% ethylene, 0.7% acrylic acid, 0.5% ATBS, and 0.7% acrylamide.

For the VAE copolymers of Example 7, the estimated copolymer composition is: 67% vinyl acetate, 30.8% ethylene, 1% acrylic acid, 0.5% ATBS, and 0.7% WAM.

### Aqueous Dispersion of VAE Copolymers of Comparative Example 1

The recipe and procedure of Example 1 was repeated except that the only functional monomer added to the reactor was acrylic acid. The weight percent of acrylic acid added to the reactor is shown in Table 1.

For the VAE copolymers of Comparative Example 1, the estimated polymer composition is: 67.4% vinyl acetate, 31.1% ethylene, 0.5% ATBS and 1% acrylic acid.

### Aqueous Dispersion of VAE Copolymers of Comparative Example 2

The recipe and procedure of Example 1 was except that the only functional monomer added to the reactor was acrylamide. The weight percent of acrylamide added to the reactor is shown in Table 1.

For the VAE copolymers of Comparative Example 2, the estimated polymer composition is: 67.4% vinyl acetate, 30.1% ethylene, 0.5% ATBS, and 2% acrylamide.

For Examples 1-7 and Comparative Examples 1-2, the weight percent of the functional monomers added to the reactor to form the VAE copolymers thereof is as shown below Table 1.

TABLE 1

| Example/Comparative | Acrylic Acid | Acrylamide | VTES | WAM |
|---|---|---|---|---|
| Example | | | | |
| Example 1 | 0.75 | 2 | 0.25 | |
| Example 2 | 0.75 | 2 | | |
| Example 3 | 1 | 2 | | |
| Example 4 | 1 | 1.5 | 0.25 | |
| Example 5 | 1 | 2 | 0.25 | |
| Example 6 | 0.75 | 0.75 | | |
| Example 7 | 1 | | | 0.75 |
| Comparative Example 1 | 1 | | | |
| Comparative Example 2 | | 2 | | |

### Aqueous Dispersion of VAE Copolymers of Example 8

The procedure of Example 1 was generally followed for Example 8, with the following notable exceptions:
1. the delay feed included an amount of vinyl acetate of 1002 g;
2. the total ethylene fed into the reactor was in an amount of 650 g;
3. the amount of Aerosol® A-102 fed into the reactor was 191 g.
4. Bruggolite® FF6M, which was supplied by Bruggemann Chemical U.S. Inc., was utilized instead of sodium erythorbate on a 1:1 mass basis; and
5. hydroxy ethyl acrylate (referred to in Table 2 as “HEA”) was utilized as a functional monomer and added to the mixture with the delay feed of vinyl acetate.

For the VAE copolymers of Example 8, the estimated copolymer composition is: 63.1% vinyl acetate, 31.9% ethylene, 1.4% acrylic acid, 0.2% vinyl triethoxy silane, 0.5% ATBS, and 2.9% hydroxy ethyl acrylate.

### Aqueous Dispersion of VAE Copolymers of Example 9

The procedure of Example 8 was generally followed for Example 9, except that acrylamide was utilized in place of hydroxy ethyl acrylate, which is illustrated in Table 2.

For the VAE copolymers of Example 9, the estimated copolymer composition is: 63.7% vinyl acetate, 32.2% ethylene, 1.5% acrylic acid, 1.9% acrylamide, 0.5% ATBS, and 0.2% vinyl triethoxy silane.

### Aqueous Dispersion of VAE Copolymers of Example 10

The autoclave was charged with 800 g of water, 8.8 g of Aerosol® MA-80-1, 0.5 g of sodium acetate, 2.0 g of a 5% solution of ferrous ammonium sulfate. The pH of the charge was adjusted to 4.2 with 2.0 g of acetic acid. Agitation was begun and 262.5 g of vinyl acetate was charged.

After the initial charging, the reactor was purged with nitrogen followed by a purge with ethylene and heated under agitation to 55° C., then 400 g of ethylene was charged. To initiate polymerization a solution of 10% sodium persulfate/5% sodium bicarbonate was fed at 0.8 g/min and an 5.5% solution of sodium erythorbate was also fed at 0.8 g/min. Upon evidence of an exotherm, two additional feeds were begun. The first feed comprised a mixture of 1035 g of vinyl acetate and 19.2 g of acrylic acid and the second feed consisted of 185.8 g water, 37.8 g of Rhodapex® EST/30-SK, which was supplied by the Solvay Group, 19.2 g of ATBS 50, and 57.7 g of acrylamide 50% solution in water. Both feeds were delivered to the reactor uniformly over 150 minutes. When the monomer feeds were begun, the temperature was ramped from 55° C. to 65° C. over 30 minutes and then held at 65° C. for the remainder of the reaction. After the pressure had peaked, additional ethylene was added as needed to maintain a running pressure in the reactor of 1025 psi, the ethylene addition was complete when a total of 625 g of ethylene were added, after which the pressure was allowed to decay.

The addition rates of the sodium persulfate and sodium erythorbate solutions were adjusted over time in an effort to obtain a uniform conversion profile. Both of these additions were terminated at about 190 minutes after the initial exotherm was observed and 200 g of each solution had been added.

The reactor contents were then cooled to 35° C. then transferred to a 3 gallon autoclave where vacuum was used to remove any unreacted ethylene. After removing the unreacted ethylene, 1 g of Rhodaline® 670 was added to reduce foaming, followed by 2 g of sodium erythorbate in 20 g of water, then 2 g of t-butyl hydroperoxide (70%) in 10 g of water. The contents were allowed to mix for 15 minutes and were then removed.

For the VAE copolymers of Example 10, the estimated copolymer composition is: 65.6% vinyl acetate, 31.4% ethylene, 1% acrylic acid, 0.5% ATBS, and 1.5% acrylamide.

For Examples 8-10, the weight percent of the functional monomers added to the reactor to form the VAE copolymers thereof is as shown below Table 2.

TABLE 2

| Example | Acrylic Acid | Acrylamide | VTES | HEA |
|---|---|---|---|---|
| Example 8 | 1.5 | | 0.25 | 3 |
| Example 9 | 1.5 | 2 | 0.25 | |
| Example 10 | 1 | 1.5 | | |

The aqueous dispersions of Examples 1-10 and Comparative Examples 1-2 were utilized to formulate aqueous roof coating compositions according to the following recipe:

| INGREDIENTS | LBS |
|---|---|
| Grind | |
| Water | 184.63 |
| Aqueous Dispersion of VAE Copolymers at 55.4 wt % solids | 172.43 |
| Dispersant (Tamol 165, Dow Chemical) | 14.00 |
| Ammonium Hydroxide | 1.50 |
| Surfactant (Surfynol ® AD01, Evonik Industries) | 2.00 |
| Foam Control Agent (Drewplus ™ TS-4481, Ashland) | 2.00 |
| Titanium dioxide pigment (Ti-Pur R-706, Chemours Company) | 100.00 |
| CaCO₃ Filler (Atomite ®) | 300.00 |
| Talc Filler (Talcron ® MP 12-50, Speciality Minerals) | 110.00 |
| Letdown | |
| Aqueous Dispersion of VAE Copolymers at 55.4 wt % solids | 287.57 |
| Foam Control Agent (Drewplus TS-4481, Ashland) | 4.00 |
| Rheology Modifier (Acrysol RM-825, Dow Chemical) | 2.53 |
| Ammonium Hydroxide | 1.25 |
| Water | 11.18 |
| TOTAL | 1193.08 |

The Grind mixture was mixed at a high speed and once the pigment was dispensed the Letdown mixture was added admixed. The resulting aqueous roof coating compositions were white in color, had a 41% PVC, and exhibited a 50.8% volume solid.

### Comparative Example 3 and Comparative Example 4

Comparative Example 3 and Comparative Example 4 are commercially available liquid roof coating compositions. It is believed that the liquid roof coating compositions of Comparative Example 3 and Comparative Example 4 are acrylic-based compositions and are marketed as passing the performance requirements of the ASTM D6083 standard.

Selected aqueous roof coating compositions of Examples 1-10 were applied, dried, and tested for tensile strength (before and after Xenon Arc weathering) elongation (before and after Xenon Arc weathering), water swell, permeance, and adhesion to galvanized metal as described below. The aqueous roof coatings of Comparative Examples 1-2 were dried and tested for tensile strength (before and after Xenon Arc weathering) and elongation (before and after Xenon Arc weathering) only. The liquid roof coating compositions of Comparative Example 3 and Comparative Example 4 were applied, dried, and tested for tensile strength (before and after Xenon Arc weathering) elongation (before and after Xenon Arc weathering), water swell, permeance, and adhesion to galvanized metal as described below. Descriptions of the testing methods are provided below. The results of the testing of Examples 1-10 and Comparative Examples 1-4 are reported in Table 3, below.

### Tensile Strength and Elongation at Break Tests

The test method for tensile strength and elongation at break before accelerated weathering was based on ASTM D-2370 (July 2016). Tensile strength and elongation at break were both measured using specimens 76.2 millimeters (mm) long and 12.7 mm wide and 0.50+/−0.05 mm at 23+/−2° C. and a relative humidity of 50+/−10% with a crosshead speed of 25.4 mm/min, gage length 25.4 mm.

Tensile strength and elongation at break were also both measured after 1000 hours of xenon arc accelerated weathering. The test method for tensile strength and elongation at break after accelerated weathering was based on ASTM D4798 (July 2016) for the indicated time period. The cycle used was A, uninsulated black panel temperature was 63+/−3° C., daylight filter was used, total minimum radiant energy used was 1260 KJ/(m² nm) at 340 nm, 151.2 MJ/m² at 300 to 400 nm.

The results reported in Table 3 for tensile strength are in pounds per square inch (psi) and the results reported in Table 3 for elongation at break are a percentage (%). For tensile strength, the requirement to pass the ASTM D6083 standard is 200 psi or more. For elongation, the requirement to pass the ASTM D6083 standard is 100% or more.

### Water Swell Test

The test method for water swell was based on ASTM D471 (July 2016). Water swell was measured using circular specimens of a 645.16 mm² diameter. Initial weights of the specimens were recorded at 23+/−2° C. and a relative humidity of 50+/−10%. Next, the specimens were submerged in distilled water for 168+/−4 hours After removing a specimen from the water, the weight of the specimen was determined and the percentage of weight gain was calculated. Thus, the results in Table 3 for water swell are reported as a percentage (%). The requirement for a roof coating to pass the ASTM D6083 standard is a swell of less than 20%.

### Water Permeance Test

The test method for water permeance was based on ASTM D1653 (June 2013). Water permeance was measured using specimens at 23+/−2° C. and a relative humidity of 50+/−10%. The test was conducted using method A with the cup in the inverted position and water in contact with the coating, Weights of the perm cups are recorded over time to calculate perm value in inch pound units (US perms). The requirement for a roof coating to pass the ASTM D6083 standard is a permeance of less than 50 US perms.

### Adhesion to Galvanized Metal Test

The test method was based on ASTM C₇₉₄ for measuring wet adhesion on galvanized steel panels:

### Preparation of Test Samples:

A galvanized panel was cleaned with Simple Green® available from Sunshine Makers, Inc. to remove storage oil. After rinsing with water, the galvanized panel was dried overnight at 120° F. in an oven. After allowing the panel to cool, a first layer of the aqueous roof coating composition is applied to the panel. A piece of Uniflex® polyester roofing fabric, which as one inch wide, was then placed on the wet first layer. A second layer of the aqueous roof coating composition was applied in such a manner that the roofing fabric was embedded between the first layer and the second layer and the total dry coating film thickness was 0.5 mm+/−10%. The panel was allowed to dry for 336 hours at a constant 23+/−2° C. and 50+/−10% relative humidity.

After drying, the specimen was submerged for 168 hours in tap water at 23+/−2° C. Wet adhesion was tested immediately after soaking and the panels were still wet during testing. Testing was conducted by pulling the free end of the roofing fabric, angled at 180 degrees, away from the bottom of the panel at a rate of 2 inches per minute with an Instron measuring instrument (Model 4464).

Three pulls were made per strip of fabric. One inch of fabric was pulled per test. The average force required to pull the fabric is reported in Table 3. The results in Table 3 are reported as pounds per linear inch (PLI) and the requirement to pass the ASTM D6083 standard for adhesion to galvanized metal is a value of 2 PLI or more. It should be noted that the failure type for certain examples is also reported in Table 3, where “A” stands for an adhesive failure, “C” stands for a cohesive failure, and “A/C” indicates that both failure modes were observed. It should also be noted that a cohesive failure indicates that the coating remains on the substrate and the fabric versus an adhesive failure where the coating is removed entirely. Cohesive failure is preferred.

TABLE 3

| | | | | | | | Adhesion to | |
|---|---|---|---|---|---|---|---|---|
| Example/ | Tensile | | Weathered | Weathered | Water | Water | Galvanized | |
| Comparative | Strength | Elongation | Tensile | Elongation | Swell | Permeance | Metal | |
| Example | (psi) | (%) | (psi) | (%) | (%) | (US Perm) | (PLI) | |
| 1 | 280 | 228 | 353 | 165 | 8 | 10 | 3.5 | C |
| 2 | 246 | 219 | 307 | 178 | 10 | 14 | 1.7 | C |
| 3 | 274 | 252 | 345 | 187 | 10 | 8 | 1.9 | C |
| Comparative | 159 | 229 | — | — | — | — | — | |
| Example 1 | | | | | | | | |
| Comparative | 177 | 216 | — | — | — | — | — | |
| Example 2 | | | | | | | | |
| 4 | 256 | 211 | 340 | 158 | 10 | 13 | 3.4 | C |
| 5 | 307 | 209 | — | — | 7 | — | 2.6 | C |
| 6 | 161 | 134 | — | — | 8 | — | 3.2 | C |
| 7 | 242 | 109 | — | — | 4 | 6 | 2.5 | A/C |
| 8 | 186 | 336 | — | — | 25 | — | 2.6 | C |
| 9 | 240 | 284 | — | — | 19 | — | 3.1 | C |
| 10 | 222 | 274 | — | — | 18 | 12 | 3.7 | A/C |
| Comparative | 200 | 221 | 485 | 161 | 8 | 9 | 1.8 | C |
| Example 3 | | | | | | | | |
| Comparative | 182 | 431 | 332 | 293 | 24 | 37 | 2.0 | A |
| Example 4 | | | | | | | | |

As shown in Table 3, the roof coating compositions of Examples 1-5, 7, 9 and 10 all passed the requirements of the ASTM D6083 standard with respect to tensile strength and elongation. In stark contrast, Comparative Examples 1-2, and 4 did not pass the ASTM D6083 standard. All examples tested for tensile and elongation after accelerated weathering pass the ASTM D6083 standard.

The roof coating compositions of Examples 1-4, 7, 9 and 10 all passed the requirements of the ASTM D6083 standard with respect to water swell, which was not the case for Comparative Example 4. All examples tested for permeance passed the ASTM D6083 requirement. Additionally, the roof coating compositions of Examples 1 and 4-10 all passed the requirements of the ASTM D6083 standard with respect to adhesion to galvanized metal. Furthermore, the roof coating compositions of Examples 1 and 4-10 all passed the requirements of the ASTM D6083 standard with respect to adhesion to galvanized metal. In stark contrast, the roof coating composition of Comparative Example 3 did not pass the ASTM D6083 standard.

The roof coating compositions of Examples 1 and 4 passed all of the ASTM D6083 requirements tested. In stark contrast Comparative Examples 3 and 4 failed one or more of the requirements of the ASTM D6083.

From the foregoing detailed description, it will be apparent that various modifications, additions, and other alternative embodiments are possible without departing from the true scope and spirit. The embodiments discussed herein were chosen and described to provide the best illustration of the principles of the invention and its practical application to thereby enable one of ordinary skill in the art to use the invention in various embodiments and with various modifications as are suited to the particular use contemplated. As should be appreciated, all such modifications and variations are within the scope of the invention.

1-25. (canceled)

26. An aqueous roof coating composition, comprising:
an aqueous dispersion comprising vinyl acetate ethylene copolymers that include
a) 50 to 70% by weight of vinyl acetate,
b) 20% or more by weight of ethylene,
c) 0.1 to 5% by weight of a first functional comonomer, the first functional comonomer being acrylic acid, and
d) 0.1 to 5% by weight of a second functional comonomer, the second functional comonomer being acrylamide; and
a filler
wherein the aqueous roof coating composition comprises 35 to 55% by weight vinyl acetate ethylene copolymer solids, 25 to 40% by weight of the filler, optionally 1 to 15% by weight of pigment, and optionally other additives, the % by weight of the solids, filler, and pigment being based on the total solids of the composition,
wherein the vinyl acetate ethylene copolymers exhibit a Tg of −25 to −15° C., the Tg being determined by differential scanning calorimetry with a heating rate of 10° K per minute according to ASTM D3418-82 as an onset temperature.

27. The aqueous roof coating composition of claim 26, further comprising one or more UV-VIS absorbers in an amount of 0.01 to 2 wt %, based on the weight of copolymer solids of the composition.

28. The aqueous roof coating composition of claim 27, wherein one or more UV-VIS absorber is present an amount of 0.01 to 0.5 wt %, based on the weight of copolymer solids of the composition.

29. The aqueous roof coating composition of claim 27, wherein the one or more UV-VIS absorber includes 4-methyl benzophenone.

30. The aqueous roof coating composition of claim 26, wherein the composition contains no protective colloids.

31. The aqueous roof coating composition of claim 26, wherein the vinyl acetate ethylene copolymers comprise 0.1 to 2% by weight of the first functional comonomer.

32. The aqueous roof coating composition of claim 26, wherein the vinyl acetate ethylene copolymers comprise a total of 1 to 5% by weight of the first functional comonomer and the second functional comonomer.

33. The aqueous roof coating composition of claim 26, wherein the vinyl acetate ethylene copolymers further comprises a third functional comonomer which is an ethylenically unsaturated sulphonic acid or a salt thereof.

34. The aqueous roof coating composition of claim 26, wherein the vinyl acetate ethylene copolymers include ethylene in an amount of 30 to 40% by weight.

35. The aqueous roof coating composition of claim 26, further comprising an emulsifier in an amount of 0.1 to 3% by weight.

36. The aqueous roof coating composition of claim 26, wherein the aqueous roof coating composition when dried exhibits a water swell of 20% or less after being submerged in water for 168 hours, the water swell being measured by recording an initial weight of a specimen at 23+/−2° C. and a relative humidity of 50+/−10%, submerging the specimen in distilled water for 168+/−4 hours, and, thereafter, removing the specimen from the water and determining the weight of the specimen and the percentage of weight gain.

37. The aqueous roof coating composition of claim 26, wherein the aqueous roof coating composition when dried exhibits a tensile strength of 200 psi or more using a specimen 76.2 mm long, 12.7 mm wide, and 0.50+/−0.05 mm thick at 22.8° C. and a relative humidity of 50% with a crosshead speed of 25.4 mm/min and gage length 25.4 mm and an elongation at break of 100 to 500% using a specimen 76.2 mm long, 12.7 mm wide, and 0.50+/−0.05 mm thick at 22.8° C. with a crosshead speed of 25.4 mm/min and gage length 25.4 mm.

38. The aqueous roof coating composition of claim 26, wherein the aqueous roof coating composition when dried exhibits a permeance of 50 US perms or less at 22.8° C. and a relative humidity of 50% in accordance with ASTM D1653 (June 2013).

39. A method of making an aqueous roof coating, comprising:
forming a mixture of water, vinyl acetate monomers, and ethylene by directing the vinyl acetate monomers and ethylene into a reactor containing water;
pressurizing the reactor to 800 psi or more;
reacting the vinyl acetate monomers, ethylene, a first functional comonomer, and a second functional comonomer by way of a radically initiated, polymerization process in the presence of an emulsifier to form vinyl acetate ethylene copolymers comprising 20% or more by weight of ethylene and exhibiting a Tg of −25 to −15° C., wherein 2 to 20% by weight of the vinyl acetate monomers, based on the total weight of the mixture in the reactor, remain unreacted while vinyl acetate monomers are being fed into the reactor; and
mixing the vinyl acetate ethylene copolymers with a filler to form an aqueous roof coating composition as claimed in claim 26.

40. The method of claim 39, wherein a first amount of vinyl acetate monomers are directed to the reactor as an initial charge and a second amount of vinyl acetate monomers are fed to the reactor in a second amount.

41. The method of claim 39, wherein the reactor is pressurized to between 800 and 1600 psi.

42. The method of claim 39, wherein the % by weight of unreacted vinyl acetate monomers in the mixture is maintained within a predetermined range during the polymerization process.

43. The method of claim 40, further comprising feeding the first functional comonomer and the second functional comonomer into the reactor after the first amount of the vinyl acetate monomers are fed into the reactor.

44. The method of claim 39, wherein 4 to 8% by weight of the vinyl acetate monomers, based on the total weight of the mixture in the reactor, remain unreacted while the vinyl acetate monomers are being fed into the reactor.

45. The method of claim 39, wherein the emulsifier is anionic and present in an amount of 3% or less based on by weight, based on the total weight of the monomers.
